(19) United States
(12) Patent Application Publication
(10) Pub. No.: US 2025/0229709 A1
(43) Pub. Date: Jul. 17, 2025

(54) DEVICE AND METHOD FOR TRIM LIGHTING IN VEHICLE

(71) Applicant: LACKS ENTERPRISES, INC., Grand Rapids, MI (US)

(72) Inventors: David WALTERS, Shelbyville, MI (US); Thomas HAWKINS, Grand Rapids, MI (US)

(73) Assignee: LACKS ENTERPRISES, INC., Grand Rapids, MI (US)

(21) Appl. No.: 19/169,375

(22) Filed: Apr. 3, 2025

Related U.S. Application Data
(63) Continuation-in-part of application No. 18/479,232, filed on Oct. 2, 2023.
(60) Provisional application No. 63/412,608, filed on Oct. 3, 2022.

(51) Int. Cl. B60Q 3/54; B60Q 1/26; B60R 13/02; B60R 13/04

(52) U.S. Cl. CPC B60Q 3/54; B60Q 1/2653; B60R 13/02; B60R 13/04; B60R 2013/0287

(57) ABSTRACT

A trim component having a substrate used for an interior or an exterior of a vehicle includes a support structure securely coupled to the substrate, a carrier securely attached to the support structure, at least one light source fixedly attached to the carrier, and an optic element placing over the at least one light source to disperse light from the at least one light source. The optic element is attached to the carrier or the support structure to cover the at least one light source and configured to provide a sealing feature to protect against the ingress of debris or other contaminants into the interior space. Further, the optic element is directly attached to the surface of the at least one light source.

### CROSS-REFERENCE TO RELATED APPLICATIONS

The present application is a Continuation-in-part of U.S. patent application Ser. No. 18/479,232, filed Oct. 2, 2023, which claims the benefit of U.S. Provisional Patent Application No. 63/412,608, filed Oct. 3, 2022, the entire contents of which are each incorporated by reference in their entirety.

### FIELD

The present disclosure relates to a trim component for vehicles. More particularly, the present disclosure relates to a trim lighting component for vehicles.

### BACKGROUND

The statements in this section merely provide background information related to the present disclosure and may not constitute prior art.

There is an increasing demand for lighting fixtures in interior and exterior automotive applications to meet the requirements of new and more complicated designs. The automotive industry is incorporating more complicated designs involving the use of molded plastic components of different materials to achieve a multi-functional purpose. Decorative components, such as a decorative component disposed on automotive products in one example, are typically used to add an aesthetic feature to appeal to a variety of tastes of potential consumers. Consumer decisions on whether to buy one particular product relative to another can be substantially affected by appearance, especially in cases of similarly functioning products.

The ability to illuminate parts selectively using techniques such as multi-shot injection or overmolding, or assembly of separate pieces to a common carrier that incorporate transparent or translucent zones in combination with opaque finished plastic surfaces meets demands currently found in the automotive market space. The use of injection molded plastic as a waveguide has been developed. Typically, the component uses polycarbonate (PC) or polymethylmethacrylate (PMMA) as the resin of choice to carry light. PC has a number of favorable attributes that make it well suited as an option such as good optical quality and good mechanical properties, but it suffers from poor UV stability and scratch resistance. PMMA has better UV stability than PC but does not perform as well in impact situations. The issues with UV exposure in the case of PC can be overcome with additives in the resin to increase resistance but increases the cost of the resin and typically adds some yellowing to the resin. Scratch resistance can be enhanced with the use of silicone hardcoats which may also contain UV stabilizers to protect the underlying substrate. The additional application of the hardcoat requires an extra processing step which adds cost to the part.

The automotive industry is increasingly interested in incorporating metalized plastic parts into trim component of vehicles. Further, the industry is also increasingly interested in developing trim components that provide unique and effective finishes and/or visual effects through lighting features. Accordingly, it is desirable for improvements to be made in design and construction of decorative automotive components having lighting features.

### SUMMARY

The present disclosure improves the optical efficiency of a light source via a silicone lens incorporated in the lighting source of the trim component of the vehicle. According to an exemplary form of the present disclosure, a trim component having a substrate used for an interior or exterior of a vehicle includes a support structure securely coupled to the substrate, a carrier securely attached to the support structure, at least one light source fixedly attached to the carrier, and an optic element placed over the at least one light source to disperse light therefrom.

According to a further aspect of the present disclosure, the optic element is directly attached to the carrier to cover the at least one light source. The optic element is formed with a first surface directed toward the at least one light source and a second surface directed outward toward an opposite side from the first surface. The first surface of the optic element may be spaced apart from a surface of the at least one light source to form an interior space. The optic element can be configured to provide a sealing feature to protect against the ingress of debris or other contaminants into the interior space.

According to a further aspect of the present disclosure, the optic element is attached to the support structure to cover the at least one light source. The trim component can further include a sealing member placed over the optic element to provide a sealing feature to protect against the ingress of debris or other contaminants into an interior space.

According to a further aspect of the present disclosure, the first surface of the optic element may be formed with a flat shape to attach to the at least one light source and the second surface may be formed with a convex shape to disperse the light. Further, in another approach, the second surface of the optic element may be also formed with a concave shape to disperse the light.

According to a further aspect of the present disclosure, the trim component includes at least one curved surface defining a disrupted reflective surface and at least one facet formed over the at least one curved surface configured to reflect an incident light beam from the at least one light source. The at least one facet may have a radius of curvature preferably between 5 mm and infinity.

According to a further aspect of the present disclosure, the at least light source includes a LED or laser. Further, the optic element is formed of a silicone and is a transparent or translucent light-transmissive lens.

According to another aspect of the present disclosure, a method of forming a trim component having a light source assembly for an interior or exterior body of the vehicle includes the steps of providing a carrier securely coupled to the trim component, providing at least one light source securely attached to the carrier, and placing an optic element over the at least one light source to disperse light from the at least one light source. Further, the method includes the step of providing a support structure to securely attach the carrier to the trim component.

According to a further aspect of the present disclosure, the step of placing the optic element over the at least one light source includes the step of attaching the optic element directly to the carrier or to the support structure. Further, the method further includes the step of providing a sealing member placed over the optic element to provide a seal.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a front view of a trim component in a vehicle in accordance with an exemplary form of the present disclosure;

FIG. 2 is an enlarged portion of the trim component shown in the vehicle of FIG. 1;

FIG. 3 is a cross-sectional view of the enlarged portion of the trim component having a light source assembly with an optic element, lined 3-3 of FIG. 2;

FIG. 4 is a cross-sectional view of the trim component having a light source assembly with an optic element in accordance with another embodiment of the trim component of FIG. 3;

FIG. 5 is a cross-sectional view of the trim component having a light source assembly with an optic element in accordance with another embodiment of the trim component of FIG. 3, and FIG. 5A is an enlarged portion of the light source assembly of FIG. 5;

FIG. 6 is a cross-sectional view of the trim component having a light source assembly with an optic element in accordance with another embodiment of the trim component of FIG. 3, and FIG. 6A is an enlarged portion of the light source assembly of FIG. 6;

FIG. 7A shows an enlarged portion of a disrupted reflective surface in the trim component of FIG. 3, and FIG. 7B shows an enlarged portion of a disrupted reflective surface in accordance with another embodiment of the trim component of FIG. 3;

FIG. 8 is a schematic cross-sectional exploded view of an automotive trim component having a carrier structure, a PCB assembly including an LED for being mounted to the carrier, a silicone lens for being attached over the PCB and LED, and a cover according to an aspect of the disclosure;

FIG. 9 is a perspective exploded view of the component of FIG. 8;

FIG. 10 is a perspective exploded view of another embodiment of a component according to another aspect of the disclosure;

FIG. 11 is an assembled view of the component of FIG. 8;

FIG. 12A illustrates the lens having a surface texture; and

FIG. 12B illustrates the lens having a smooth surface finish and including a diffusing agent within the lens body.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

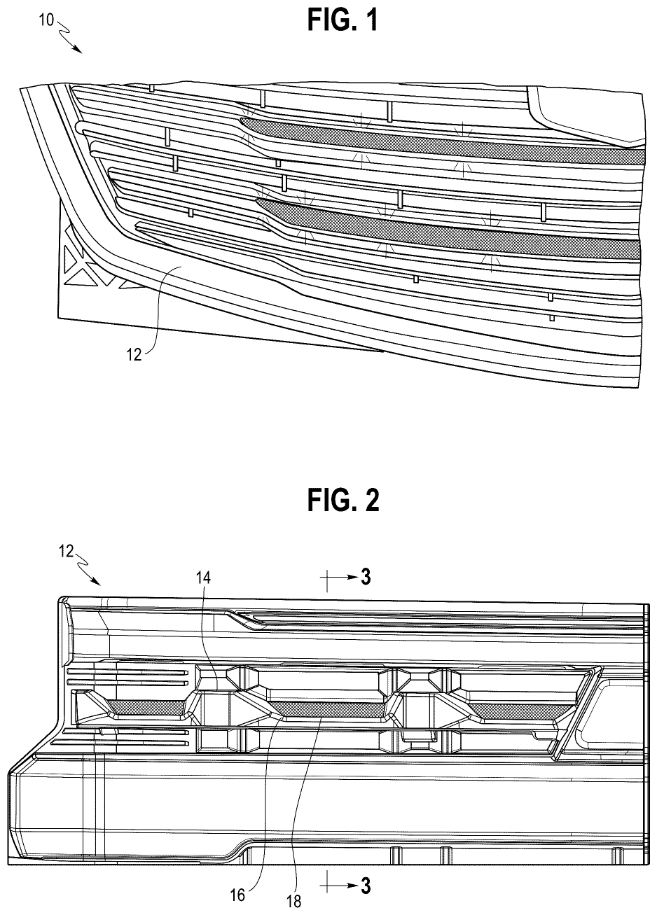

FIGS. 1 and 2 show a trim component 12 used in an interior or exterior body of a vehicle 10. In accordance with an exemplary embodiment of the present disclosure, the trim component 12 may be formed on an interior surface of the vehicle such as a door lever housing, a speaker trim, etc., and also formed on an exterior surface of the vehicle such as a grill, a pillar cover, etc. As shown in FIG. 2, the trim component 12 may be a decorative exterior component for the vehicle 10, such as the grill of the vehicle 10. However, the placement of the trim component 12 is not limited to the areas described above, and may include other areas of the vehicle 10.

As shown in FIG. 2, the trim component 12 includes a substrate 14 having a 3-dimensional shape and defining a disrupted reflective surface 16 including a plurality of facets 18 over an exterior surface. In some embodiments, the exterior surface may have a curve, such as a convex, concave, or a complex curve. In other embodiments, the disrupted reflective surface 16 may be flat or substantially flat. For example, the facets 18 may be integrally formed in the substrate 14 and may be formed by the molding of the substrate 14. Each of the facets 18 is configured to maximize reflection of an incident light beam 22 in a common direction, for example, toward a given target. The facets 18 may be irregular with progressively tilted surfaces by different degrees, surfaces having a repeating pattern, sizes varying in a size gradient based on the curvature of the curved surface, etc.

Additional detail regarding the use of a substrate and facets for a reflective surface are contained in Applicant's U.S. Pat. No. 10,988,084, filed Jun. 25, 2019 and issued Apr. 27, 2021, which was previously published as U.S. Patent Publication No. 2019/0389412 on Dec. 26, 2019, and the entire content of each of these publications is incorporated by reference in their entirety.

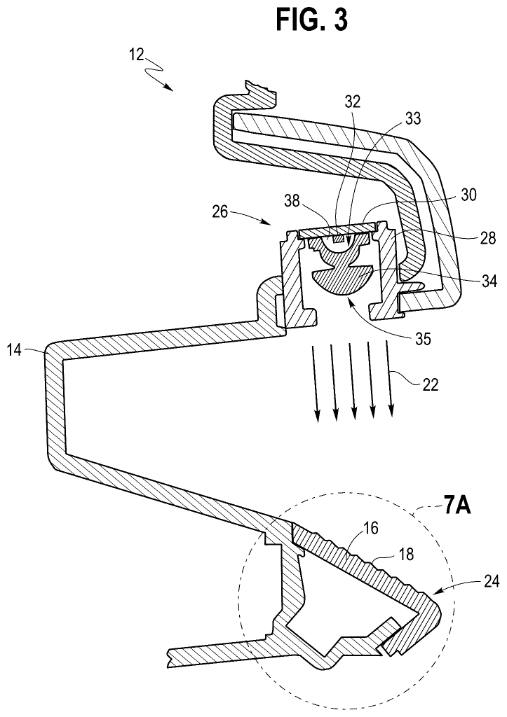

The reflective coating 24 (see FIG. 3) may be an electroplated chrome, although other types of reflective coatings may be used such as a Physical Vapor Deposition (PVD) coating, a hot-stamp film, or an insert-molded film. The substrate 14 may be made of a material that includes one or more of Acrylonitrile Butadiene Styrene (ABS), a blend of Polycarbonate with ABS (PC-ABS), a blend of ABS with Polycarbonate (ABS-PC), Polyamide, and/or Aramid. In some embodiments, the substrate 14 may be injection molded.

FIG. 3 shows a cross-sectional view of a portion of the trim component 12 comprising at least one light source assembly 26, which is lined 3-3 of FIG. 2. The light source assembly 26 can include a support structure 28, a carrier 30 such as a printed circuit board (PCB), a light source 32, and an optic element 34 in accordance with an exemplary embodiment of the present disclosure. As shown in FIG. 3, the support structure 28 may be securely attached to the substrate 14 of the trim component 12 and the carrier 30 may also be fixedly coupled to the support structure 28 by an interference fit or other bonding methods such as adhesive. Further, the light source 32 is configured to illuminate the disrupted reflective surface 16. The light source 32, for example, may include one or more LEDs, incandescent lights, lasers, or other devices capable of producing visible light.

As shown in FIG. 3, the light source 32 may produce and direct the incident light beam upon the disrupted reflective surface 16, which reflects therefrom as a reflective light beam. In some embodiments, the light source 32 may be a diffuse light source, producing the incident light beam which spreads out over a relative wide area of the disrupted reflective surface 16. Alternatively, the light source 32 may be a focused light source, producing the incident light beam which does not spread out over a wide area of the disrupted reflective surface 16 and which is directed to a relative narrow area of the disrupted reflective surface 16. Further, the light source 32 may include one or more optical elements 34 such as lenses and/or diffusers to distribute light across the disrupted reflective surface 16 or to focus light upon a specific area of the disrupted reflective surface 16.

In some embodiments, the light source 32 may be located on or within a concealed surface at the underside of an overhanging portion of the trim component 12 or may be recessed within the substrate 14. Accordingly, the light source 32 may be configured to be directly or indirectly visible to a viewer. For example, the light source 32 would not be visible from a perspective of an intended viewer, who may be located directly in front of or at an elevated position relative to the trim component 12. Therefore, lighting provided by the light source 32 may enhance the look of the metallized trim component, making it more visible while reducing back reflection from other sources.

Further, the light source 32 may produce light having a single, predetermined color, such as white. Alternatively, the light source 32 may produce several different colors of light at the same time and/or different times. In some embodiments, the light source 32 may be configured to vary in intensity and/or color over time according to a sequence. For example, the light source 32 may cycle through different colors and/or different intensities over a period of time that is sufficiently long enough for a viewer to perceive the different intensity and/or colors being produced. The sequence or cycle may include two or more different colors. In some embodiments, multi-color effects may be produced with different regions of the disrupted reflective surface 16 having different colors at the same time and/or at different times. In one example, the light source 32 may generate a multi-color light pattern upon the disrupted reflective surface 16, with each of the different colors being visible simultaneously, and with different colored portions of the disrupted reflective surface 16 varying in color, location, and/or intensity over time.

As shown in FIG. 3, according to one aspect, the light source assembly 26 includes the light source 32 such as a LED, laser, etc., and the optic element (i.e., lens) 34 formed of a silicone. In FIG. 3, the optic element 34 (i.e., a silicone optic lens) is directly attached to the carrier 30 to cover the light source 32 and also configured to transmit light therethrough and disperse light therefrom. Further, the optic element 34, being made of silicone, may have sufficient flexibility to provide a sealing function relative to the carrier 30 to protect against the ingress of debris or other contaminants into an interior space 38 formed inside the optic element 34 or into contact with the light source 32. When assembled with the carrier 30, the optic element 34 and its outer edge may be pressed into contact and flex slightly to create the seal.

In some embodiments, further, the light source assembly 26 includes a plurality of optic elements 34 that may be molded separately or connected by light pipes in lines that represent a single molding containing two or more lensing units (not shown). The silicone optic lens 34 may be transparent or translucent, and also is configured to be light transmissive and operable as an optical waveguide for light, such that light generated by the underlying the light source 32 will be transmitted and guided through the structure and shape of the optic lens 34 and dispersed therefrom. In this aspect, as shown in FIG. 3, the optic lens 34 may be also referred to as a light guide such that the optic lens 34 may include a first surface 33, which receives the light from the light source 32 and a second surface 35, which is visible to a viewer. So, the light passes through the body of the optic lens 34 and thereafter is transmitted through the second surface 35 to be directed toward the disrupted reflective surface 16.

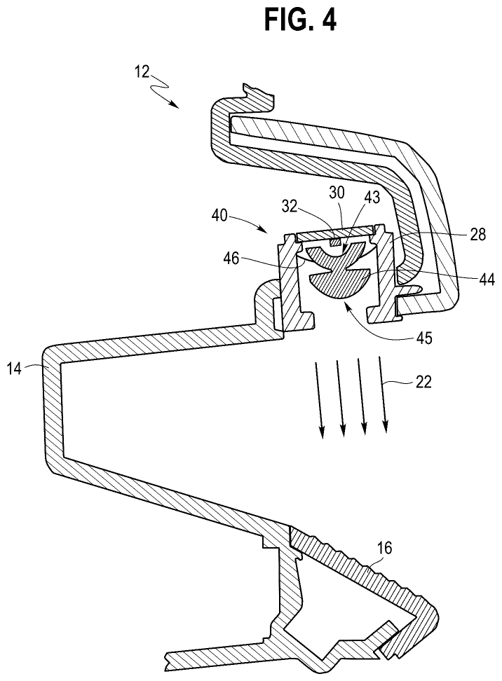

FIG. 4 shows another embodiment of a silicone optic lens 44 used in a light source assembly 40. As shown in FIG. 4, the design of the silicone optic lens 44 is similar to the design of the silicone optic lens 34, which is shown in FIG. 3. However, in FIG. 4, the silicone optic lens 44 is attached to other structures (e.g., support structure or substrates) other than the light source 32 and the carrier 30. For example, the silicone optic lens 44 is securely and directly attached to the support structure 28 to cover the light source 32. As described above, the silicone optic lens 44 itself may have sufficient flexibility to provide a sealing feature to protect against the ingress of debris or other contaminants into the interior space 38 or into contact with the light source 32. In another approach, further, the light source assembly 40 further includes a sealing member 46 placed over the outside of the silicone optic lens 44 such that the silicone optic lens 44 with the sealing member 46 provides protection against debris or other contaminants as a separate component. In some embodiments, the sealing member 46 may be formed together with the optic lens element as a single unit (i.e., the sealing member may be formed in the same ‘SHOT’ as the optic lens element) such that the sealing member 46 is used to form a sealing window to provide protections against debris or other contaminants.

In FIG. 4, the silicone optic lens 44 may be transparent or translucent, and also is configured to be light transmissive and operable as an optical waveguide for light, such that light generated by the underlying light source 32 will be transmitted and guided through the structure and shape of the optic lens 44 and dispersed therefrom. As shown in FIG. 4, further, the optic lens 44 may be also referred to as a light guide such that the optic lens 44 may include a first surface 43, which receives the light from the light source 32 and a second surface 45, which is visible to a viewer. So, the light passes through the body of the optic lens 44 and thereafter is transmitted through the second surface 45 to be directed toward the disrupted reflective surface 16.

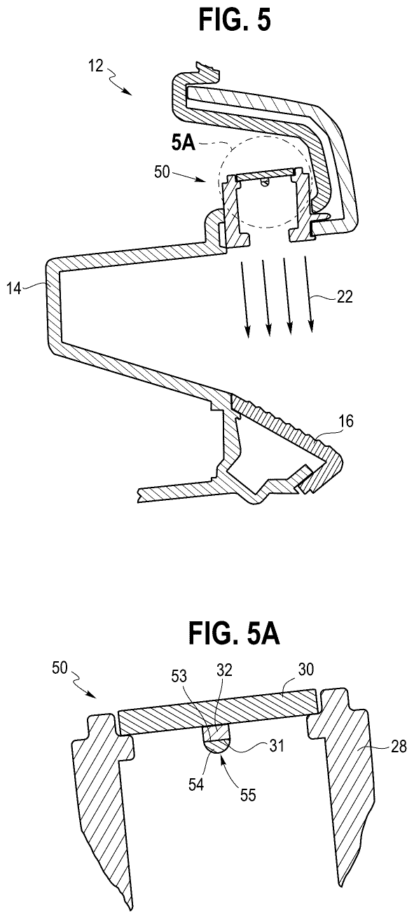

FIGS. 5 and 5A show another embodiment of a silicone optic lens 54 used in a light source assembly 50. As shown in FIG. 5A, the silicone optic lens 54 may include a first surface 53 formed with a flat shape to directly or indirectly attach to a surface 31 of the light source 32 (e.g., LED) and a second surface 55 formed a curved shape (e.g., a convex shape) visible to a viewer. Further, the silicone optic lens 54 attached to the light source 32 may cover entirely or partially the surface 31 of the light source. As shown in FIGS. 5 and 5A, the silicone optic lens 54 may be transparent or translucent, and also is configured to be light transmissive and operable as an optical waveguide for light, such that light generated by the underlying light source 32 will be transmitted and guided through the structure and shape of the optic lens 54 and dispersed therefrom. So, the light passes through the body of the optic lens 54 and thereafter is transmitted through the second surface 55 to be directed toward the disrupted reflective surface 16.

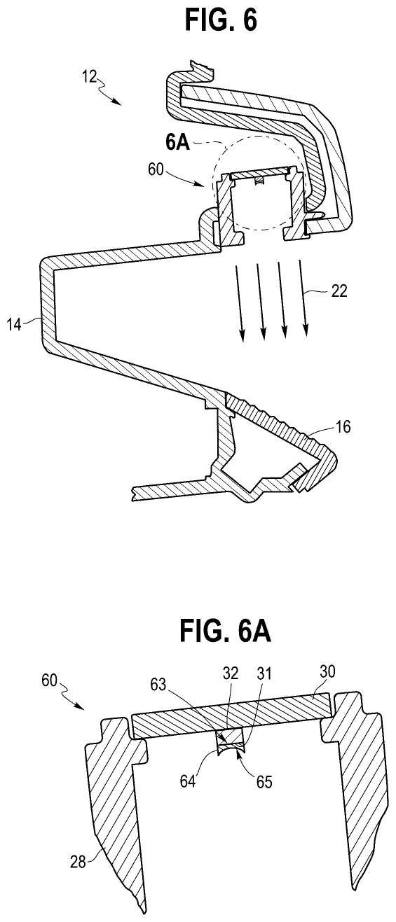

FIGS. 6 and 6A show another embodiment of a silicone optic lens 64 used in a light source assembly 60. As shown in FIG. 6A, the silicone optic lens 64 may include a first surface 63 formed with a flat shape to directly or indirectly attach to the surface 31 of the light source 32 (e.g., LED) and a second surface 65 formed a curved shape (e.g., a concave shape) visible to a viewer. Further, the optic element 64 attached to the light source 32 may cover entirely or partially the surface 31 of the light source 32. Further, the silicone optic lens 64 may be transparent or translucent, and also is configured to be light transmissive and operable as an optical waveguide for light, such that light generated by the underlying the light source 32 will be transmitted and guided through the structure and shape of the optic lens 64 and dispersed therefrom. So, the light passes through the body of the optic lens 64 and thereafter is transmitted through the second surface 65 to be directed toward the disrupted reflective surface 16.

Further, the optic lenses 34, 44, 54, and 64 described above in the present disclosure, may be configured to increase their optical efficiency by more than 40%. Due to the design shapes of the optic lenses 34, 44, 54, and 64 above in the present disclosure, they can enable over 40% more light output for the same input, or the same light output with over 40% energy savings in driving the lighting module. Accordingly, the optic lenses in the present disclosure reduce the size and cost of the electrical system and further extend the driving range of the battery electric vehicle. In some embodiments, the shape of the optic lenses may vary and also various other surface arrangements or orientations may be provided depending on the arrangement and shape of the trim component having the lighting feature including the optic lenses described above. Further, the various designs of the optic lenses described above in the present disclosure may be changed and modified according to the desired optic-pattern.

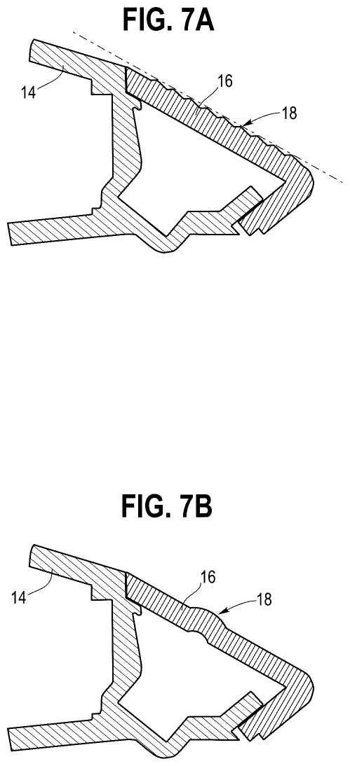

Referring back to FIG. 3, the disruptive reflective surface 16 includes a plurality of facets 18 over the exterior surface. FIGS. 7A and 7B shows a detailed view of the disruptive reflective surface 16 having the facets formed with different design to improve reflection of the incident light beam 22 from the light source 32. The shape of the facets 18 may be dependent on the level of diffusion desired for the reflected light beam and the curvature of the curved surface. Further, the design and orientation of the facets 18 may be mathematically determined during the design stage. For example, FIG. 7A shows the surface of the facets having an infinite radius of curvature and FIG. 7B shows the surface of a facet having 5 mm radius of curvature such that the surface of the facets 18 in the present disclosure has radius of curvature preferably between 5 mm and infinity. Further, as shown in FIG. 3, the facets 18 may be formed together with the rest of the substrate, for example by molding or casting the substrate 14.

Other constructions of the light source assembly 26 may be found in U.S. Patent Publication No. 2024/0110688, published Apr. 4, 2024, the entire content of which is incorporated by reference in its entirety.

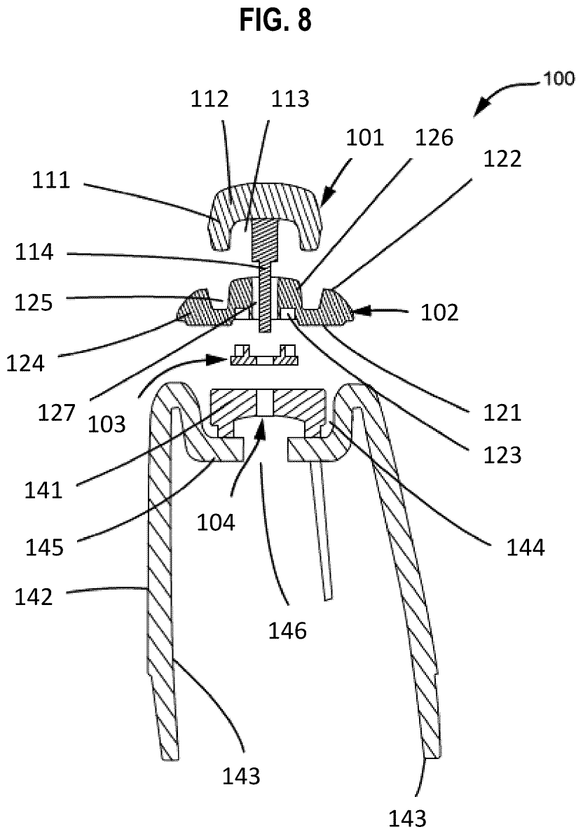

FIGS. 8-12B illustrates an additional embodiment of a light source and lens assembly including a silicone lens for use with an automotive trim component, and the aspects of this additional embodiment may be used in any of the above embodiments. Similarly, the aspects of the prior-described embodiments may be used with the below described additional embodiment.

FIG. 8 depicts a cross-section of a decorative exterior automotive trim component 100 in an exploded view. However, it will be appreciated that the automotive trim component 100 may also be disposed in interior locations and may have other cross-sectional shapes.

As shown, the component 100 includes a carrier 104 for providing a mounting structure for a LED light source 103, a silicone lens 102, and a decorative cover 101 disposed across the top of the component 100. The lens 102 may also be referred to as an optic lens or optical lens, and is configured to transmit light therethrough and disperse light therefrom. The decorative cover 101 may also be referred to as a cap or a decorative plastic part. The cover 101 may also be made from another material other than plastic. However, the plastic form of the cover may be preferable for cost, ease of assembly, appearance, etc.

In one aspect, the component 100 may be in the form of an elongate roof rail, with the carrier 104, lens 102, and cover 101 having elongate shapes. The light source 103 may be in the form of a plurality of LEDs spaced along the elongate shape of the roof rail, with the spacing provided as desired depending on the desired lighting effect. Alternatively, the light source 103 may be a laser or other light source. Because the lens 102 may function as a light pipe, the light source 103 may be located in select areas while still providing illumination throughout the extent of the lens 102.

It will be appreciated that various embodiments of the present disclosure and of the component 100 are possible.

For example, in one aspect, the decorative cover 101, for example, can contain a number of different finishes, and is not necessarily limited to a decorative chrome finish. The decorative cover 101 may be electroplated chrome, painted, may employ MIC (mold in color), or may utilize other types of finishes, such as decorative film. The finish of the cover 101 may be textured, matte, or glossy. The ultimate finish type may be determined and/or controlled by the process used to create the finish, and the variety of possible specifications used for each process. For example, in an electroplating process, the specifications of the electroplating system may be adjusted or tailored to create different levels of surface roughness and/or smoothness. In another aspect, the finish may be created using post-plating processes such as abrasion. The cover 101 may have multiple finishes, including multiple chrome finishes or appearances, or may be a combination of chrome plating and paint. The cover 101 is sized and shaped to fit together with the lens 102, such that the lens 102 and cover 101 have corresponding mating structures. It will be appreciated that various types of corresponding structures may be used.

With regard to the lens 102, the lens 102 is constructed of a silicone material, rather than a PC or PMMA material. The silicone material used in the lens 102 is naturally UV resistant, and does not require the use of UV absorbing additives as in the use of PC material, thereby providing an improvement relative to PC material. Silicone materials also have excellent thermal and impact properties, thereby providing an improvement relative to PMMA material.

Additionally, silicone materials have a “tuneable” durometer, thereby providing increased flexibility in the design of the overall component 100 and its material and performance properties. For example, the formulation of the silicone material used in the lens 102 can be “tuned” or altered to make the material more flexible (for example, a durometer of approx. 70 Shore A) in cases where some level of surface flexing is required. This relatively softer composition of the material can thereby serve a dual purpose, where the silicone material of the lens 102 can also be used to provide sealing to wire holes and exposed LEDs/PCBs that are disposed adjacent the lens 102, and to reduce NVH (noise, vibration, and harshness) and BSR (buzz, squeak, and rattle). In some instances, isolation gaskets/gimps can be eliminated by combining the gasket/gimp function with the original optical lens 102 component made of the relative softer silicone material described above.

Silicones for the lens 102 can be formed using a RIM process (reactive injection molding) to form the structure and shape of the lens 102. This RIM process uses two liquid components (one of them containing a catalyst) that are metered and injected into a mold cavity. One of the liquid components is a water-like solution, which allows the silicone to reach very tight corners and crevices that other more viscous molten resins cannot reach. In the RIM process, the mold cavity is heated, which heats the solution, and a chemical reaction takes place in the heated cavity, converting the oligomers of the material into a formed solid. In one aspect, the viscosity of the liquid is typically in the 15 k-30 k Pa/sec range. This level of viscosity allows the silicone material to replicate very fine detail engraved on the surface of the mold cavity. The fine detail of the mold, replicated into the molded component, can be used for aesthetic purposes, and can also be used to diffuse or redirect light in a desired manner through the use of engineered surface structures, such as a textured internal or external surface of the lens 102.

With reference again to FIG. 8, the silicone optic lens 102 may be transparent or translucent. Whether transparent or translucent, the lens 102 is configured to be light transmissive and operable as an optical waveguide for light, such that light generated by the underlying LED light source 103 will be transmitted and guided through the structure and shape of the lens 102 and dispersed therefrom. In this aspect, the lens 102 may also be referred to as a light guide. Accordingly, the lens 102 may include one or more surfaces through which light is received (such as the bottom surface of the lens 102 adjacent the light source 103), with the light passing through the body of the lens 102, and thereafter the light is transmitted through one or more surfaces visible to a viewer, such as the upper surface of the lens 102 that is not covered by the cover 101.

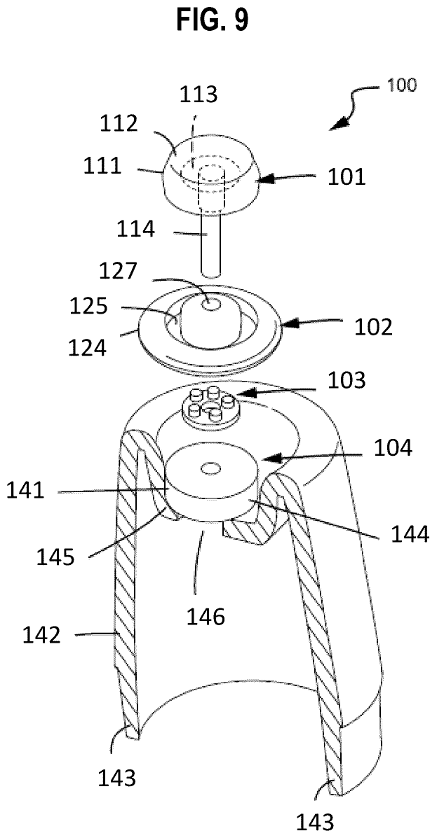

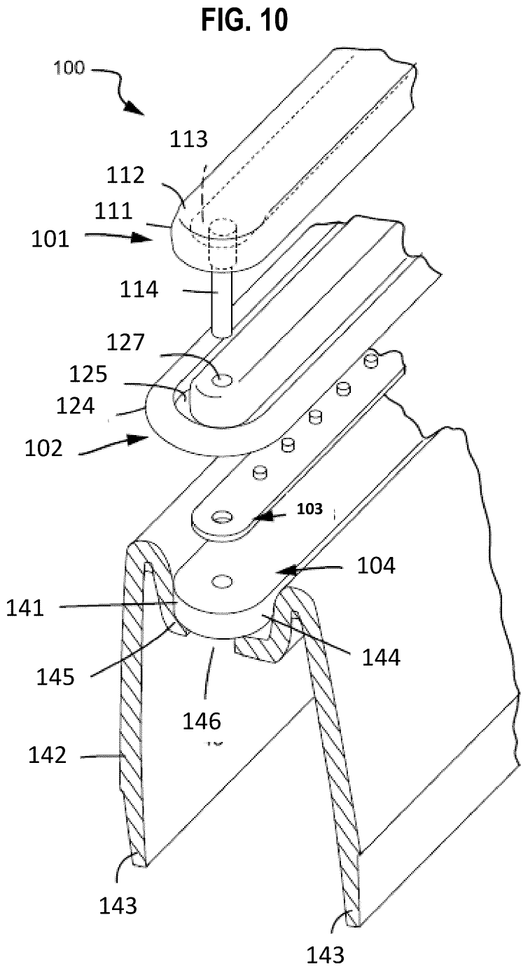

As shown in FIG. 8, a bottom surface 121 (or inner surface) of the lens 102 may be configured to receive light from the light source 103, with an upper surface 122 (or outer surface) configured to the transmit the light from the light source 103. It will be appreciated that the ultimate shape of the lens 102 may vary and that various other surface arrangements or orientations may be provided depending on the arrangement and shape of the automotive component 100 having the lighting feature. For example, as discussed previously, the component 100 may have an elongate shape, with the lens 102 and cover 101 being elongated. In one aspect, the lens 102 may be elongated, as in FIG. 10, and a series of covers 101 may be disposed over select locations of the lens 102. In another aspect, the component 100 may have an annular shape, as in FIG. 9, and the lens 102 may have an annular profile, along with the cover 101 and the carrier 104. It will be appreciated that these alternative shapes are provided for illustrative purposes, and that various shapes of the assembled components are contemplated depending on the type of component being produced.

With reference to the embodiment shown in FIG. 8, the lens 102 includes a lower cavity 123 sized and arranged to include recesses, depressions, or the like that correspond to the projecting shape of the LED components that project from the PCB of the LED light source 103. The cavity 123 may have a width that corresponds to the width of the LED light source 103. Accordingly, the lens 102 is configured to cover, receive, and/or enclose the LED light source 103 therein. The cavity 123 may include the bottom surface 121 that is configured to receive light waves transmitted by the LED light source 103. It will be appreciated that other arrangements and shapes of the light source 103 and/or its PCB may be provided, and the bottom surface 121 and cavity 123 may be sized and configured to receive the various corresponding projections and/or shapes of the light source 103.

As shown in FIG. 8, the lens 102 may further include lateral or radial projecting side portions 124 as shown in the cross-section of FIG. 8. It will be appreciated that the cross-section of FIG. 8 may be representative of either an elongate or an annular shaped lens 102 and cover 101. For purposes of discussion here, the annular shape of the lens 102 of FIG. 8 will be described.

At the radial outer edge of the lens 102, the lens may include depressions or recesses, such as concave depressions, configured to correspond to the structural shape of the carrier 104 where these edges will mate with the carrier structure. The lens 102, being made of silicone having the flexibility described above, may have sufficient flexibility to provide a sealing function relative to the carrier 104 to protect against the ingress of debris or other contaminants into the carrier structure or into contact with the light source 103. When assembled with the carrier 104, the lens 102 and its outer edge may be pressed into contact and flex slightly to create the seal. In the non-assembled and non-flexed state, the lens 102 and the carrier 104 may have structure that would otherwise interfere, such that the structure at the edge of the lens 102 that is shaped to correspond with the carrier will differ slightly to promote the flexing and sealing force provided by the assembly of the lens 102.

The lens 102 may further include, at its upper surface 122, a channel 125 formed therein that extends downward into the lens body. As shown in FIG. 8, the channel 125 may be annular, and may be disposed generally radially outward relative to the cavity 123 of the bottom surface 121. The channel 125 may be sized and configured to correspond to the shape of the cover 101, in particular a downward projection of the cover 101, such that the cover 101 may be received, at least partially, within the channel 125 and secured thereto. The channel 125 may be defined radially between a radially outer side portion 1124 and a central section 126 of the cap.

However, in another aspect, the lens 102 may include other structure at its upper surface 122 configured to correspond to the shape of the cover 101 that will mate with the lens 102. For example, rather than an annular recess/depression/channel, an annular projection may extend up from the lens 102 and be configured to be received in an annular channel on the lower surface of the cover 101. Various other cooperating structures between the cover 101 and the lens 102 may be used.

The channel 125, or other cooperating structure, may have non-annular shapes as well, for instance in the case of an elongate component 100. For example, the channel 125 may have an elongate continuous shape, or may be in the form of a series of channels or other cavities/depressions. Similarly, in the case of an upward projection from the lens 102, the projection may have a continuous elongate shape or a series of elongate shapes. The cover 101 may likewise have corresponding projections or cavities such that the cover 101 and lens 102 may fit together along the interface therebetween.

With reference now to the cover 101, the cover 101 may be sized and configured to include a bottom surface or shape corresponding to that of the upper surface or shape of the lens 102. Accordingly, with reference to the illustrated annular lens 102, the cover 101 may include a radially outer annular projection 111 extending downward from a top portion 112 of the cover 101. The downward outer projection 111 is sized and shaped to correspond to the size and shape of the channel 125 of the lens 102. The outer projection 111 accordingly defines a cavity 113 radially/laterally within. This cavity 113 is sized and shaped to receive the corresponding central projection 26 of the lens 102.

Again, it will be appreciated that the size and shape of the cap or cover 101 and lens 102 may ultimately be arranged differently without departing from the spirit and scope of the present disclosure, and that the described shapes are for discussion purposes. For example, both annular and elongate shapes may be used, and varying corresponding projections and cavities may be used between the cover 101 and the lens 102.

The cover 101 may also include a downwardly projecting pin or post 114, extending downwardly from the top portion 112 and configured to extend through a central portion of the lens 102, the LED light source 103, and the carrier 104. The lens 102 accordingly may include a bore 127 corresponding to the shape of the post 114. The LED light source 103 and carrier 104 may include similar bores/openings/holes, or the like configured to allow passage of the post 114 therethrough.

In one aspect, the post 114 may be threaded at its terminal end to allow for the provision of a nut or other fastener to secure the cover 101 relative to the carrier 104. The post 114 may also include a barbed end or the like configured to provide a snap-fit. In another aspect, the post 114 may have a slightly larger diameter than that of the bore 127 of the flexible lens, thereby creating a frictional retention force on the post 114 when the cover 101 is installed.

The cover 101, according to an aspect of the disclosure, is opaque and configured to block light from being transmitted therethrough, in contrast to the light-transmitting configuration of the lens 102. Thus, the top portion 112 and the projection 111 that are coupled to the lens 102 block the light that is being guided through the lens 102 at this interface between the cover 101 and the lens 102. The cover 101, however, does not fully cover the lens 102. Put another way, the lens 102 includes an outer exposed portion of the upper surface 122, such that light transmitted through the lens 102 acting as a light guide is made visible in these exposed portions to the viewer. The visible portion(s) of the lens 102 are disposed radially outward, in the annular version, relative to the location of the LEDs of the light source 103, such that light is transmitted from the location of the LEDs radially outward, through the outer portion 1124 of the lens 102, and to the exposed portion of the upper surface 122.

As illustrated, the LEDs of the light source 103 are disposed below the cover 101, such that the cover 101 overlies the LEDs. The area where the light is visible is laterally adjacent the cover 101. Thus, the light is transmitted outward and provided to a location that is remote from the location of the light source 103. In one aspect, the LEDs may also be disposed radially inward relative to portion 11, such that the LEDs are disposed within the cavity 113 formed in the cover 101. Light from the LEDs will still transmit and propagate through the material of the lens 102 such that light is visible in the radially outer exposed and visible portions of the lens 102.

With reference now to the carrier 104, the carrier 104 is shown in FIG. 8 as having a first portion 141 connected with a second portion 142. The second portion 142 may include a pair of opposed sidewalls 143 that extend upward and then inward to provide a mounting surface for the first portion 141. The first portion 141 may therefore be referred to as an inner portion and the second portion 142 may be referred to as an outer portion. The first portion 141 may have a plate-like structure with a flat upper surface for supporting the PCB of the light source 103.

The second portion 142 may define a cavity 144 recessed below the uppermost surface of the second portion 142, with a flange portion 145 offset and disposed below the uppermost surface. The first portion 141 is received in the cavity 144 and supported by the inwardly extending flange portion 145, with an upper surface of the first portion 141 generally corresponding in height to the uppermost surface of the second portion 142 when the first portion 141 is received in the cavity 144, or the upper surface of the first portion 141 may be slightly recessed below the uppermost surface of the second portion 142. The flange portion 145 may include an opening 146 defined in a central portion thereof and disposed below the first portion 141. The opening 146 may provide access for electrical connections to the LED light source 103 and/or may receive the post 114 of the cap or cover 101. The first portion 141 may also include a central opening through which the post 114 extends.

The carrier 104 may also be in the form of a unitary structure in which the first and second portion 141 and 142 are part of a continuous one-piece structure. The carrier 104 may be in the form of injection molded plastic or the like. The carrier 104 is preferably opaque, such that the light from the light source 103 is not visible through the carrier 104, and the light therefore remains limited to the exposed and visible portions of the lens 102. The carrier 104 may have an annular or elongate shape, or other shapes sized and configured to support and retain and light source 103, lens 102, and cover 101 according to the present disclosure.

In one aspect, the carrier 104 may be plated or painted, similar to the cover 101. The carrier may be formed in a manner similar to that which was described in reference to the cover 101.

The carrier 104 may, in one aspect, be in the form of a roof rail. In another aspect the carrier may be a vehicle grille. In another aspect, the carrier may be any other exterior vehicle body trim, or may be an interior decorative trim component. Thus, it will be appreciated that the underlying shape and structure of the carrier 104 may vary depending on the placement and use of the component 100, while still providing the benefits of the aspects of the disclosure described herein.

In one aspect, the component 100 may be provided as a sub-assembly of one of more parts described above. For example, the light source 103 and first portion 141 of the carrier 104 may be assembled together initially, possibly along with the lens 102 and the cover 101, with this sub-assembly thereafter being attachable to the second portion 142 of the carrier 104. It will be appreciated that different sub-assemblies of the component 100 may also be utilized, and may be attached to other shapes of the second portion 142 of the carrier. Alternatively, a given shape of the second portion 142 of the carrier may be provided that can receive alternative constructions of the sub-assembly of the first portion 141, the light source 103, the lens 102, and the cover 101.

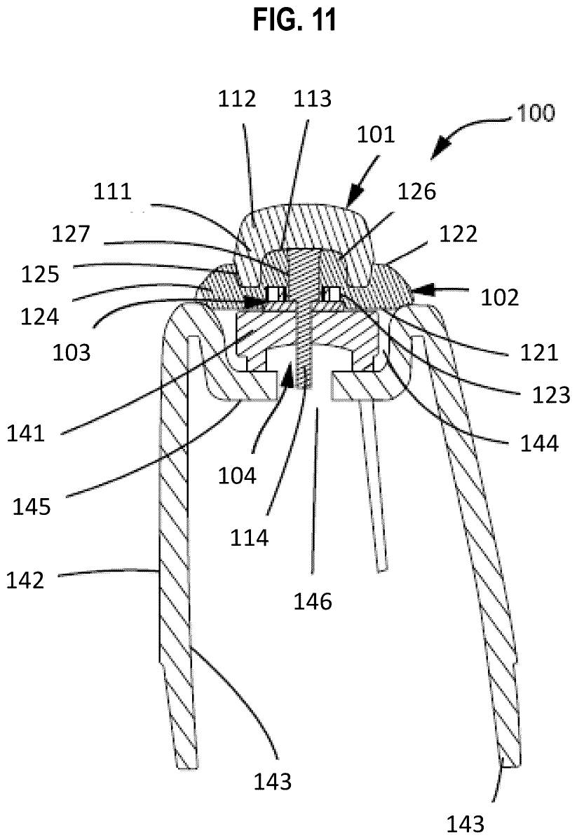

FIG. 11 illustrates the above-described components in an assembled state, whether using a sub-assembly prior to attachment to the second portion 142 of the carrier 104, or with the components assembled in a different order.

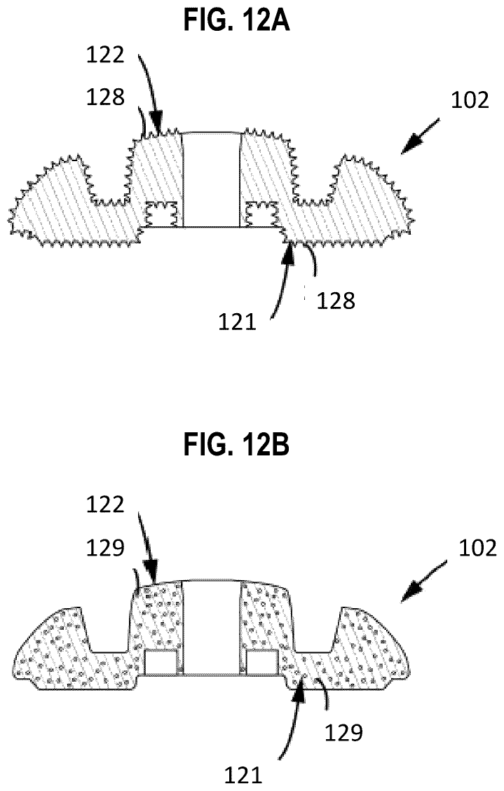

With reference to FIGS. 12A and 12B, the lens 102, via its method of formation described above, can also incorporate texture on a surface thereof (FIG. 12A) (such as via a texture in the mold), with the formed texture providing diffusion, or the lens 102 may have a smooth surface finish (FIG. 12B). In one aspect, the roughened surface texture 128 may be in the form of a molded microtexture, but other forms of roughening may also be used. It will be appreciated that illustrated microtexture is schematic in nature and not to scale. In one aspect both the inner and outer surfaces have the roughened surface texture 128, but it will also be appreciated that one surface may have a roughed surface texture and the other surface may be smooth. It will also be appreciated that portions of the inner and/or outer surface may be roughened while other portions remain smooth. For example, in FIG. 12A, the entire outer surface is shown having the roughened surface finish, but for areas that are going to be covered, such areas may not include the texture, with the portions intended to be visible having the texture. In another aspect, the lens 102 may be formed from a resin that is formulated with a diffusing agent 129 in the bulk resin used in the molding process. The presence of a diffusing agent 129 may be used alone or in combination with a formed texture on the surface on the lens 102 to provide diffusion. Furthermore, the lens 102 may be clear or may be colored with an additive to the resin. Because the silicone has the properties described previously, it does not need the additional step of having a hardcoat on the outer facing side. The lack of a hardcoat reduces the number of steps to provide a light transmissive lens that is UV resistant and suitable for automotive applications, such as exterior automotive trim components.

In view of the above, the component 100 may provide the desirable light-enhanced decorative component for an automobile or other product, and may provide such features without requiring costly UV protective coatings and without sacrificing durability, as in PC and PMMA lenses/materials, and furthermore without sacrificing high-level appearance and fidelity of the light feature that is desirable to consumers.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A trim component having a substrate used for an interior or exterior of a vehicle, the trim component comprising:
a support structure securely coupled to the substrate;
a carrier securely attached to the support structure;
at least one light source fixedly attached to the carrier; and
an optic element placed over the at least one light source to disperse light from the at least one light source.

2. The trim component of claim 1, wherein the optic element is attached directly to the carrier to cover the at least one light source.

3. The trim component of claim 1, wherein the optic element is formed with a first surface directed inward toward the at least one light source and a second surface directed outward toward an opposite side from the first surface.

4. The trim component of claim 3, wherein the first surface of the optic element is spaced apart from a surface of the at least one light source to form an interior space.

5. The trim component of claim 4, wherein the optic element is configured to provide a sealing feature to protect against the ingress of debris or other contaminants into the interior space.

6. The trim component of claim 1, wherein the optic element is attached to the support structure to cover the at least one light source.

7. The trim component of claim 6, further comprising a sealing member placed over the optic element as a separate component to provide a sealing feature to protect against the ingress of debris or other contaminants into an interior space.

8. The trim component of claim 6, further comprising a sealing member formed with the optic element as a single unit to provide a sealing feature such that the sealing member is used to form a sealing window.

9. The trim component of claim 3, wherein the first surface of the optic element is formed with a flat shape to attach to the at least one light source and the second surface is formed with a convex shape to disperse the light.

10. The trim component of claim 3, wherein the first surface of the optic element is formed with a flat type to attach to the at least one light source and the second surface is formed with a concave shape to disperse the light.

11. The trim component of claim 1, wherein the trim component includes at least one curved surface defining a disrupted reflective surface and at least one facet formed over the at least one curved surface configured to reflect an incident light beam from the at least one light source.

12. The trim component of clam 11, wherein the at least one facet has radius of curvature preferably between 5 mm and infinity.

13. The trim component of claim 1, wherein the optic element is formed of a silicone and is a transparent or translucent light-transmissive lens.

14. A method of forming a trim component having a light source assembly for an interior or exterior body of the vehicle, the method comprising the steps of:
providing a carrier securely coupled to the trim component;
providing at least one light source securely attached to the carrier; and
placing an optic element over the at least one light source to disperse light from the at least one light source.

15. The method of claim 14, wherein the step of placing the optic element over the at least one light source includes the step of attaching the optic element directly to the carrier.

16. The method of claim 14, wherein further comprising the step of providing a support structure to securely attach the carrier to the trim component.

17. The method of claim 16, wherein the step of placing the optic element over the at least one light source includes the step of attaching the optic element to the support structure.

18. The method of claim 14, further comprising the step of providing a sealing member placed over the optic element to provide a seal as a separate component or formed with the optic element as a single unit.

19. The method of claim 14, wherein the optic element includes a first surface formed with a flat shape and a second surface formed with a curved shape.

20. The method of claim 19, wherein the step of placing the optic element over the at least one light source includes the step of attaching the first surface of the optic element directly to a surface of the at least one light source.
